(19) United States
(12) Patent Application Publication
(10) Pub. No.: US 2020/0378135 A1
(43) Pub. Date: Dec. 3, 2020

(54) MULTI-LAYER MODULAR FLOORING SYSTEM

(71) Applicant: Zhang Yi, Lu'An City (CN)

(72) Inventor: Zhang Yi, Lu'An City (CN)

(21) Appl. No.: 16/428,719

(22) Filed: May 31, 2019

(51) Int. Cl. E04F 15/02; B32B 7/022

(52) U.S. Cl. CPC E04F 15/02038; B32B 7/022

(57) ABSTRACT

A multi-layer modular flooring system provides a permanent covering for a ground surface. The flooring system comprises multiple floor panels that detachably fit together to cover the ground surface. The flooring system has two adjacent, parallel layers disposed flush against each other—an upper layer that is the walking surface, and a lower layer that is the layer engaged with the ground surface. The upper layer comprises a surface coating, and is shaped with a protruding portion and a corresponding recessed portion that releasably couple to each other. The lower layer is disposed flush against the upper layer, and defined by a resilient, dampening composition. A ground side of the lower layer is coated with a reusable adhesive composition that allows the floor panel to detachably adhere to the ground surface. The coupling of the protruding and recessed portions, and the reusable adhesive restrict lateral motion of the floor panels.

### CROSS REFERENCE OF RELATED APPLICATIONS

This application claims the benefits of U.S. provisional application no. APP. NO, filed DATE and entitled NO-MOVE FLOOR, which provisional application is incorporated by reference herein in its entirety.

### FIELD OF THE INVENTION

The present invention relates generally to a multi-layer modular flooring system. More so, the present invention relates to a flooring system that provides a permanent covering for a ground surface to provide a walking area; whereby the flooring system comprises multiple floor panels having two adjacent, parallel layers; whereby an upper layer comprises a surface coating, and is shaped to define a protruding portion and a corresponding recessed portion that enable adjacent floor panels to releasably couple to each other; and further having a lower layer disposed flush against the upper layer, and defined by a resilient, dampening composition and coated with a reusable adhesive composition; whereby the coupling of the protruding and recessed portions restricts lateral motion of the floor panels relative to each other, and the reusable adhesive composition on the lower layer restricts lateral motion of the floor panels relative to the ground surface.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a flooring is used to cover a ground area, so as to provide a walking surface. Those skilled in the art will recognize two primary types of floor coverings on the market. The first is a glue down flooring; and the second is a snap fit connectivity flooring. The glue down flooring requires a very flat floor and the use of glue. However, such a floor can be difficult to pave and cannot be used repeatedly. The snap fit connectivity flooring requires professional skill sets and specialty flooring tools. The snap fit connectivity flooring can be inconvenient to disassemble and easily damage the floor; especially for novices.

Other proposals have involved flooring systems. The problem with these flooring systems is that they do not remain firmly secured to the ground surface. Also, the connectivity between floor panels is difficult to assembly. Even though the above cited flooring systems meet some of the needs of the market, a multi-layer modular flooring system that eliminates the direct difference between the ground surface and the floor panels, and that provides a reusable adhesive composition that can be reused without reducing adhesion, is still desired.

### SUMMARY

Illustrative embodiments of the disclosure are generally directed to a multi-layer modular flooring system. The flooring system provides a permanent covering for a ground surface to provide a walking area. The flooring system comprises multiple floor panels that detachably fit together to cover the ground surface. The flooring system has two adjacent, parallel layers disposed flush against each other—an upper layer that is the walking surface, and a lower layer that is the layer engaged with the ground surface.

The upper layer comprises a surface coating. The upper layer is shaped to define a protruding portion and a corresponding recessed portion that enable adjacent floor panels to releasably couple to each other. The lower layer is disposed flush against the upper layer, and defined by a resilient, dampening composition. The free side of the lower layer is coated with a reusable adhesive composition that allows the floor panel to detachably adhere to the ground surface. In this manner, the coupling of the protruding and recessed portions restricts lateral motion of the floor panels relative to each other; and the reusable adhesive composition on the lower layer restricts lateral motion of the floor panels relative to the ground surface.

In one aspect, the multi-layer modular flooring system, comprises:

multiple floor panels detachably fitted together, the floor panels having:
an upper layer being coated with a surface coating, the upper layer being shaped to define a protruding portion and a corresponding recessed portion that enable adjacent floor panels to releasably couple to each other; and
a lower layer disposed flush against the upper layer, the lower layer defined by a resilient, dampening composition, the lower layer being coated with a reusable adhesive composition.

In another aspect, the floor panels are defined by an elongated shape.

the floor panels are not defined by an shape. The shape can be elongated or square.

In another aspect, the floor panels detachably fitted together to cover a ground surface.

In another aspect, the protruding portion and the recessed portion have a puzzle-shape.

In another aspect, the protruding portion has a rounded shape.

In another aspect, the recessed portion has a rounded shape.

In another aspect, the lower layer being coated with a reusable adhesive composition that allows the floor panel to detachably adhere to the ground surface

In another aspect, the upper layer has a walking side coated with the surface coating.

In another aspect, the lower layer has a ground side coated with the reusable adhesive composition.

In another aspect, the reusable adhesive composition includes at least one of the following: a thermo-resettable cross-linked polymer, a pressure sensitive adhesive, a tacky adhesive, and an acrylic glue.

In another aspect, the reusable adhesive composition is washable.

One objective of the present invention is to provide a flooring that leverages the advantages of splicing adjacent floor panels together, and adhering the floor panels to a ground surface.

Another objective is to provide easy to couple depressed and recessed portions of the floor panels that splice together to form a smooth surface.

Yet another objective is to provide a dampening cushion on the lower layer of the floor panel.

Another objective is to utilize a reusable adhesive that allows for repetitive adhering and removal of the floor panel to the ground surface, and that can be reused without reducing adhesion.

Yet another objective is to allows the floor panels to be reused through use of the reusable adhesive composition.

Another objective is to provide an inexpensive to manufacture flooring system.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates an elevated side view of an exemplary multi-layer modular flooring system, showing the upper layer and the lower layer of the floor panels, in accordance with an embodiment of the present invention; and

FIG. 2 illustrates a top view of exemplary protruding and recessed portions of the floor panels, in accordance with an embodiment of the present invention.

Like reference numerals refer to like parts throughout the various views of the drawings.

### DETAILED DESCRIPTION OF THE INVENTION

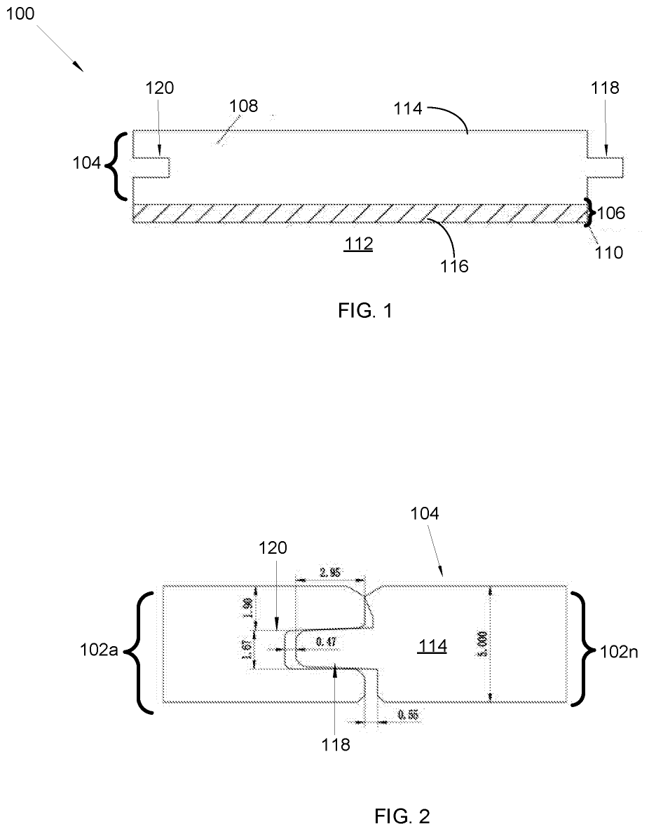

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A multi-layer modular flooring system 100 is referenced in FIGS. 1-2. The multi-layer modular flooring system 100, hereafter “system 100” is a unique flooring that is laid directly onto a ground surface 112 to provide an aesthetic, secure, non-slip flooring. The system 100 can be laid onto the ground surface 112 to form a walking surface on various types and dimensions of ground surfaces, including a subflooring.

Furthermore, the system 100 utilizes multiple floor panels 102a-n that fit together in a jigsaw puzzle arrangement, so as to enable covering variously sized, shaped, and dimensioned ground surface 112 areas. The floor panels 102a-n can accommodate different types of ground surfaces, including a concrete surface, a wooden surface, an asphalt surface, and the like. With the unique flooring system 100, laying the floor panels 102a-n onto the ground surface 112 requires minimal skills and tools, as a reusable adhesive composition 116, and a snap-fit coupling between floor panels 102a-n facilitates installation onto the ground surface 112.

As FIG. 1 shows, the system 100 comprises multiple floor panels 102a-n that detachably fit together to cover the ground surface 112. The system 100 has two adjacent, parallel layers disposed flush against each other. The layers may include an upper layer 104, which serves as the walking surface; and a lower layer 106, which serves to engage the ground surface 112 directly. The floor panels 102a-n are unique in that, once laid onto the ground surface 112, they do not slide or move in an unstable manner.

FIG. 2 illustrates a top view of exemplary protruding and recessed portions 118, 120 of the floor panels 102a-n. The system 100 utilizes a unique tongue-and-groove joint between floor panels 102a-n is used to eliminate the direct difference between each floor panel (from floor panel 102a to 102n). Thereby achieving the paving requirements.

Further, the floor panels 102a-n are coated with a reusable adhesive composition 116 that can be used repeatedly without reducing adhesion. After the glue coating is dirty, it can be washed and cleaned, and the adhesion can be restored after drying. Further, the reusable adhesive composition 116 can be reused without reducing adhesion.

In some embodiments, the system 100 consisting of multiple floor panels 102a-n detachably fitted together to cover a ground surface 112, the floor panels 102a-n have an upper layer 104 that is defined by a walking side 108. The walking side 108 is coated with a surface coating 114. The surface coating 114 may include a PVC, a tarnish, a gloss, a paint, or other floor finishes known in the art.

The upper layer 104 is shaped to define a protruding portion 118 and a corresponding recessed portion 120 that enable adjacent floor panels 102a-n to releasably couple to each other. This may include a tongue-and-groove relationship in which the protruding portion 118 and the recessed portion 120 detachably mate in a snap-fit relationship. In some embodiments, the protruding portion 118 and the recessed portion 120 have a rounded shape that allows the components to fit together more easily. In one non-limiting embodiment shown in FIG. 2, the protruding portion is about 2.95 cm long, and the recessed portion is about 1.67 cm wide. However, any dimensions for the parts of the floor panel may be used, since the system 100 is scalable.

In addition, the floor panels 102a-n have a lower layer 106 that is disposed flush against the upper layer 104. The lower layer 106 comprises a resilient, dampening composition 116, which may include a foam material. The resilient dampening composition 116 provides cushion for walking across the floor panels 102a-n. The lower layer 106 is defined by a ground side 110 that faces the ground surface 112. The reusable adhesive composition 116 that is configured to enable the floor panel to detachably adhere to the ground surface 112.

The reusable adhesive composition 116 may include, without limitation, a thermo-resettable cross-linked polymer, a pressure sensitive adhesive, a tacky adhesive, an acrylic glue, and a glue. However, in other embodiments, any flooring adhesive that may be reused is utilized. The reusable adhesive composition 116 is also washable, so that it stays sticky and smooth; and thereby can be used multiple times and also accommodates different types of ground surfaces.

In installing the system 100, the floor panels 102a-n are laid out across the ground surface 112 in a desired pattern to cover the ground surface 112. The upper layer 104 of the floor panels 102a-n is fitted together in a jigsaw puzzle arrangement, so as to achieve the desired floor covering. The protruding portion 118 is pushed into the recessed portion 120 in a snap-fit relationship. The ground side 110 of the lower layer 106 is placed onto the ground surface 112 until adhering to the ground surface 112. The walking side 108 may be wiped to create a gloss effect on the upper layer 104.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1. A multi-layer modular flooring system, the system comprising:
multiple floor panels detachably fitted together, the floor panels having:
an upper layer being coated with a surface coating, the upper layer being shaped to define a protruding portion and a corresponding recessed portion that enable adjacent floor panels to releasably couple to each other; and
a lower layer disposed flush against the upper layer, the lower layer comprising a resilient, dampening composition, the lower layer being coated with a reusable adhesive composition, and the reusable adhesive composition includes a pressure sensitive adhesive;
wherein the upper layer is defined by a walking side coated with the surface coating, and the walking side is wiped to create a gloss effect on the upper layer, and the lower layer has a ground side coated with the reusable adhesive composition.

2. The system of claim 1, wherein the floor panels are in the shape of square.

3. The system of claim 1, wherein the floor panels detachably fitted together to cover a ground surface.

4. The system of claim 3, wherein the lower layer is coated with a reusable adhesive composition that allows the floor panel to detachably adhere to the ground surface.

5. (canceled)

6. (canceled)

7. (canceled)

8. The system of claim 1, wherein the protruding portion has a rounded shape, and the protruding portion is about 2.95 cm long.

9. The system of claim 1, wherein the recessed portion has a rounded shape, and the recessed portion is about 1.67 cm wide.

10. The system of claim 1, wherein the surface coating comprises a tarnish.

11. (canceled)

12. The system of claim 1, wherein the reusable adhesive composition is washable.

13. A multi-layer modular flooring system, the system comprising:
multiple floor panels detachably fitted together to cover a ground surface, the floor panels having:
an upper layer being defined by a walking side coated with a surface coating, the upper layer being shaped to define a protruding portion and a corresponding recessed portion that enable adjacent floor panels to releasably couple to each other; and
a lower layer disposed flush against the upper layer, the lower layer comprising a resilient, dampening composition, the lower layer being defined by a ground side coated with a reusable adhesive composition that allows the floor panel to detachably adhere to the ground surface, and the reusable adhesive composition includes a pressure sensitive adhesive.

14. The system of claim 13, wherein the floor panels are in the shape of square.

15. (canceled)

16. The system of claim 13, wherein the protruding portion and the recessed portion have a rounded shape, and the protruding portion is about 2.95 cm long, while the recessed portion is about 1.67 cm wide.

17. The system of claim 13, wherein the surface coating comprises a tarnish.

18. (canceled)

19. The system of claim 13, wherein the reusable adhesive composition is washable.

20. A multi-layer modular flooring system, the system consisting of:
multiple floor panels detachably fitted together to cover a ground surface, the floor panels having:
an upper layer being defined by a walking side coated with a surface coating, the upper layer being shaped to define a protruding portion and a corresponding recessed portion that enable adjacent floor panels to releasably couple to each other, the protruding portion and the recessed portion having a rounded shape, the surface coating comprising a polyvinyl chloride; and
a lower layer disposed flush against the upper layer, the lower layer comprising a resilient, dampening composition, the lower layer being defined by a ground side coated with a reusable adhesive composition that allows the floor panel to detachably adhere to the ground surface, the reusable adhesive composition including.
